(19) United States
(12) Patent Application Publication
(10) Pub. No.: US 2020/0320387 A1
(43) Pub. Date: Oct. 8, 2020

(54) INDEPENDENT AND DEPENDENT READING USING RECURRENT NETWORKS FOR NATURAL LANGUAGE INFERENCE

(71) Applicant: KONINKLIJKE PHILIPS N.V., EINDHOVEN (NL)

(72) Inventors: REZA GHAEINI, CAMBRIDGE, MA (US); SHEIKH SADID AL HASAN, CAMBRIDGE, MA (US); OLADIMEJI FEYISETAN FARRI, YORKTOWN HEIGHTS, NY (US)

(21) Appl. No.: 16/756,270

(22) PCT Filed: Nov. 29, 2018
(86) PCT No.: PCT/EP2018/082915

§ 371 Date: Apr. 15, 2020

Related U.S. Application Data
(60) Provisional application No. 62/597,194, filed on Dec. 11, 2017.
(60) Provisional application No. 62/680,790, filed on Jun. 5, 2018.

(51) Int. Cl. G06N 3/08; G06N 3/04; G06F 40/20

(52) U.S. Cl. CPC G06N 3/08; G06F 40/20; G06N 3/0445; G06N 3/0454

(57) ABSTRACT

Techniques disclosed herein related to independent and dependent reading using recurrent networks for natural language inference. In various embodiments, data indicative of a premise (310) and data indicative of a hypothesis (312) form a natural language inference classification pair. For example, the data indicative of a premise can be processed independently using a third recurrent network (318) and data indicative of a hypothesis can be processed independently using a first recurrent network (314). Similarly, data indicative of a premise can be processed dependently using a second recurrent network (316) including data indicative of a hypothesis processed independently. Additionally, data indicative of a hypothesis can be processed dependently using a fourth recurrent network (320) including data indicative of a premise processed independently. Independent and dependent premise data can be pooled (334) together. Independent and dependent hypothesis data can be pooled (336) together.

### RELATED APPLICATION

This application claims the benefit of and priority to U.S. Provisional No. 62/597,194, filed Dec. 11, 2017, the entirety of which are incorporated by reference.

### TECHNICAL FIELD

Various embodiments described herein are directed generally to natural language processing. More particularly, but not exclusively, various methods and apparatus disclosed herein relate to independent and dependent reading recurrent networks for natural language inference.

### BACKGROUND

Natural Language Inference (NLI) is an important classification task in natural language processing (NLP). A system can be given a pair of sentences (e.g. premise and hypothesis), and the system classifies the pair of sentences with respect to three different classes: entailment, neutral, and contradiction. In other words, the classification of the pair of sentences conveys whether the hypothesis is entailed by the given premise, whether it is a contradiction, or whether it is otherwise neutral. Recognizing textural entailment can be an important step in many NLP applications including automatic text summarizers, document simplifiers, as well as many other NLP applications.

Information can be represented in different ways, with varying levels of complexity and/or ambiguity. NLI finds relationships, similarity, and/or alignment between sentences which can simplify a document and/or remove redundant information (which can lead to confusion by a reader of the document). Reducing redundancy can additionally make the content of a document more focused and/or coherent. For example, reducing redundancy can make the essence of the information become more meaningful to a reader. Existing NLI systems can use neural networks to classify the relationship (i.e. entailment, neutral, and contradiction) between a premise sentence and a hypothesis sentence. However, these techniques often rely on explicit modeling of dependency relationships between the premise and the hypothesis during the encoding and inference processes to prevent the network from losing relevant, contextual information.

### SUMMARY

The present disclosure is directed to methods and apparatus for both independent and dependent readings of natural language inference (NLI) premise and hypothesis sentence pairs for classification by neural network models. For example, in various embodiments, a deep learning based NLI method can classify the relationship between a pair of sentences with respect to generally three different classes: entailment, neutral, contradiction. For example, in various embodiments, a premise sentence and a hypothesis sentence NLI pair can be classified by the independent and dependent readings of a deep learning neural network (e.g., recurrent neural networks, long short-term memory, or “LSTM,” networks, etc.) with three classification labels: entailment, neutral, and contradiction.

Generally, in one aspect, a method may include: obtaining data indicative of a premise and data indicative of a hypothesis, wherein the data indicative of the premise and the data indicative of the hypothesis form a natural language inference classification pair; processing the data indicative of the hypothesis independently using a first recurrent network to generate first independent hypothesis data; processing the data indicative of the premise independently using a third recurrent network to generate third independent premise data; processing the data indicative of the premise dependently with the first independent hypothesis data using a second recurrent network to generate second dependent premise data; processing the data indicative of the hypothesis dependently with the third independent premise data using a fourth recurrent network to generate fourth dependent hypothesis data; pooling the second dependent premise data and the third independent premise independent data to combine independent and dependent premise data and generate pooled premise data; pooling the first independent hypothesis data and the fourth dependent hypothesis data to combine independent and dependent hypothesis data and generate pooled hypothesis data; and generating a pooled classification output by combining the pooled premise data and the pooled hypothesis data, wherein the pooled classification output is selected from the group consisting of entailment, neutral, and contradiction.

In various embodiments, the method may further include generating data indicative of an attention matrix by combining the pooled premise data with the pooled hypothesis data; generating attention softmax data by calculating the attention matrix with a softmax function; generating an additional representation of the hypothesis data by combining the pooled hypothesis data with the attention softmax data; generating an additional representation of the premise data by combining the pooled premise data with the attention softmax data; generating data representative of dependent premise attention embedding by combining the pooled premise data, the additional representation of the hypothesis data, a difference between the pooled premise data and the additional representation of the hypothesis data, and an element wise product between the pooled premise data and the additional representation of the hypothesis data; generating data representative of dependent hypothesis attention embedding by combining the pooled hypothesis data, the additional representation of the premise data, a difference between the pooled hypothesis data and the additional representation of the premise data, and an element wise product between the pooled hypothesis data and the additional representation of the premise data; generating concatenated premise vectors data using a premise projector receiving data representative of dependent premise attention embedding, wherein the premise projector is a feed-forward neural layer; and generating concatenated hypothesis vector data using a hypothesis projector receiving data representative of dependent hypothesis attention embedding, wherein the hypothesis projector is a feed-forward neural layer.

In various embodiments, the method may further include processing the concatenated hypothesis vectors data independently using a fifth recurrent network to generate fifth hypothesis independent recurrent network data; processing the concatenated premise vector data independently using a seventh recurrent network to generate seventh premise independent recurrent network data; processing the concatenated premise vectors data dependently with the fifth hypothesis independent recurrent network data using a sixth recurrent network to generate sixth premise dependent recurrent network data; processing the concatenated hypothesis vector data dependently with the seventh premise independent recurrent network data using an eight recurrent network to generate eight hypothesis dependent recurrent network data; pooling the sixth premise dependent recurrent network data and the seventh premise independent recurrent network data to combine independent and dependent premise data and generate second pooled premise data; pooling the fifth hypothesis independent recurrent network data and the eight hypothesis dependent recurrent network data to combine independent and dependent hypothesis data and generate second pooled hypothesis data; pooling the second pooled premise data to generate premise sequence pooling data which independently combines the second pooled premise data; and pooling the second pooled hypothesis data generate hypothesis sequence pooling data which independently combines the second pooled hypothesis data.

In various embodiments, the method may further include generating concatenation data of the premise sequence pooling data and the hypothesis sequence pooling data; classifying the concatenation data using a feed-forward neural layer which feeds into an additional softmax function, wherein the output of classifying the concatenation data indicates a relationship between the natural language inference pair and is selected from the group consisting of entailment, neutral, and contradiction.

In various embodiments, the method may further include wherein entailment indicates the data indicative of the hypothesis is entailed by the data indicative of the premise in a natural language inference, wherein contradiction indicates the data indicative of the hypothesis is contradicted by the data indicative of the premise in the natural language inference, and neutral indicates the data indicative of the hypothesis is not a entailed or a contradiction by the data indicative of the premise in the natural language inference.

In various embodiments, the method may further include wherein the first recurrent network is a first bidirectional long short term memory (Bi-LSTM) network, the second recurrent network is second Bi-LSTM network, the third recurrent network is a third Bi-LSTM network, the fourth recurrent network is a fourth Bi-LSTM network, the fifth recurrent network is a fifth Bi-LSTM network, the sixth recurrent network is a sixth Bi-LSTM network, the seventh recurrent network is a seventh Bi-LSTM network, and the eighth recurrent network is an eighth Bi-LSTM network.

In various embodiments, the method may further include preprocessing the data indicative of a premise and the data indicative of a hypothesis which form the natural language inference classification pair.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating various principles of the embodiments described herein.

FIG. 1 is a flowchart illustrating an example process of performing selected aspects of the present disclosure, in accordance with various embodiments.

FIG. 2 is a flowchart illustrating another example process of performing selected aspects of the present disclosure, in accordance with various embodiments.

FIG. 3A and FIG. 3B are diagrams depicting one example of input encoding in accordance with various embodiments.

FIG. 4A and FIG. 4B are diagrams depicting one examples of attention in accordance with various embodiments.

FIG. 5 is a diagram illustrating one example of inference encoding in accordance with various embodiments.

FIG. 6 is a diagram illustrating one example of classification in accordance with various embodiments.

FIG. 7 is a diagram depicting an example computing system architecture.

### DETAILED DESCRIPTION

Many existing models can use simple reading mechanisms to encode the premise and hypothesis of a natural language inference (NLI) sentence pair independently. However, in several embodiments, such a complex task can require more explicit modeling of dependency relationship between the premise and the hypothesis during an encoding and inference processes to prevent the loss of relevant contextual information in deep-learning networks. For simplicity, such strategies can be referred to as “dependent reading”.

By contrast, various techniques described herein utilize one or both of independent and dependent reading recurrent networks for natural language inference. For example, in a variety of embodiments, neural networks can perform and independent reading and a dependent reading of a premise and a hypothesis. In several embodiments, a dependent reading bidirectional long short term memory (DR-Bi-LSTM) element of a neural network model can be utilized. Given a premise u and a hypothesis v, various embodiments described herein may first encode the premise and the hypothesis independently and then encode them considering dependency on each other (i.e. encode both the premise dependently with respect to the hypothesis: u|v, and encode the hypothesis dependently with respect to the premise: v|u).

In many embodiments, the neural network model can employ an attention mechanism, for example, a soft attention mechanism, to extract relevant information from these input encodings. In a variety of embodiments, the augmented sentence representations can then be passed to an inference encoding stage, which can use a similar independent and dependent reading strategy in both directions, i.e. u→v and v→u. In many embodiments, a classification decision, for example labeling the premise hypothesis sentence pair with an entailment, neutral or contradiction label, can made through a multilayer perceptron (MLP) based on the aggregated information. In a variety of embodiments, neural network models to solve NLI problems can be divided into a variety of subsection including: input encoding, attention, inference encoding, and classification. In some embodiments, additional or alternative steps, for example a preprocessing step, can be added to any of the stages of the neural network model including: input encoding, attention, inference encoding, and classification.

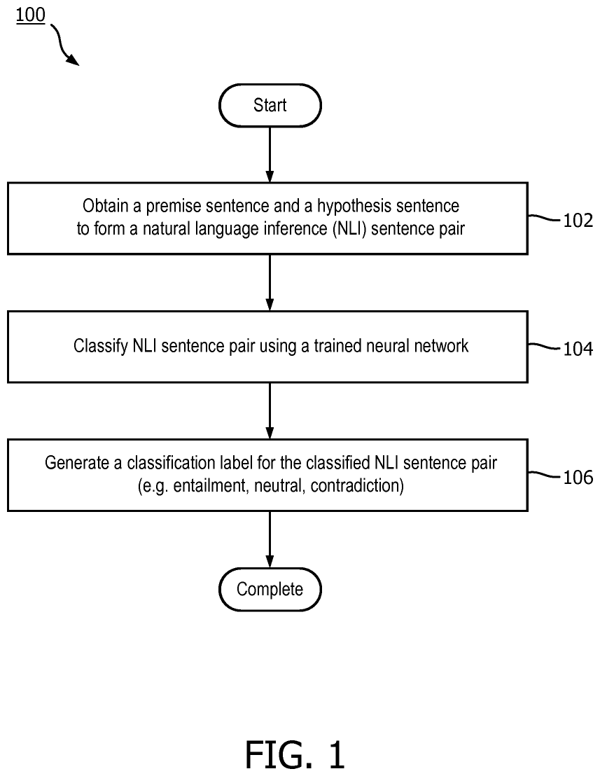

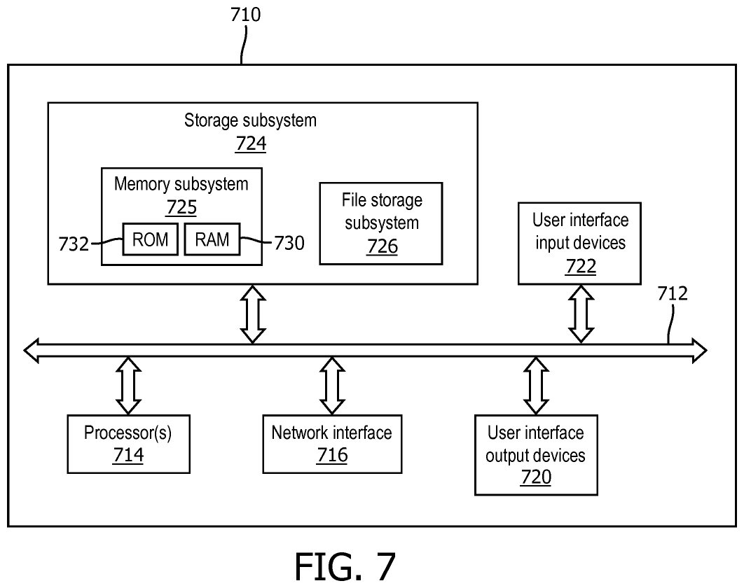

Referring to FIG. 1, an example process 100 for practicing selected aspects of the present disclosure, in accordance with various embodiments is disclosed. For convenience, the operations of the flowchart are described with reference to a system that performs the operations. This system may include various components of various computer systems, including those described in FIG. 7. Moreover, while operations of process 100 are show in a particular order, this is not meant to be limiting. One or more operations may be reordered, omitted, and/or added.

At block 102, a premise sentence and a hypothesis sentence NLI sentence pair can be obtained. A pair of NLI sentences generally can have three relationship classifications: entailment, contradiction, and neutral. An entailment classification can indicate the hypothesis sentence is related to the premise sentence. A contradiction classification can indicate the hypothesis sentence is not related to the premise sense. Additionally or alternatively, a neutral classification can indicate hypothesis sentence has neither an entailment classification nor a contradiction classification. For example, the premise sentence “A senior is waiting at the window of a restaurant that serves sandwiches.” can be linked with various hypothesis sentences. The hypothesis sentence “A person waits to be served his food.” can indicate an entailment classification (i.e., the hypothesis sentence has a relationship with the premise sentence). The hypothesis sentence “A man is looking to order a grilled cheese sandwich.” can indicate a neutral classification (i.e., the hypothesis sentence has neither entailment nor contradiction with the premise sentence). Additionally, the hypothesis sentence “A man is waiting in line for the bus.” can indicate a contradiction classification (i.e., the hypothesis sentence has no relationship with the premise sentence).

At block 104 NLI sentence can be classified using a trained neural network. The trained neural network can perform independent readings and dependent readings of the premise and hypothesis sentences. Neural network models in accordance with many embodiments of the disclosure can contain a variety of layers including: input encoding, attention, inference encoding, and classification. In many embodiments, the neural network can be a deep learning neural network, for example, a recurrent network. In many embodiments, a bidirectional Long Short Term Memory (Bi-LSTM) can be used as building blocks of the trained neural network. Additionally or alternatively, a dependent reading Bi-LSTM (DR-Bi-LSTM) can be used to both independently and dependently read premise and hypothesis sentence pairs. Additional information regarding the use of Bi-LSTM in the neural network model will be described below.

In some embodiments, a neural network can be trained using a data set with a known set of inputs corresponding to a known classification. The input is passed through the network, and one or more adjustments can be made to the neural network by comparing the actual output of the network and what the output of the network should be from the data set that corresponds with the given input. For example, the Stanford Natural Language Inference (SNLI) data set can be used to train a neural network in accordance with many embodiments of the disclosure for use in NLI applications.

At block 106, a classification label can be generated for the classified NLI sentence pair. A variety of embodiments can have three classification labels: entailment, neutral, contradiction). In other embodiments additional labels can be utilized, for example, when the NLI sentence pairs used in a training data set are labeled by one or more humans, additional classification labels can be generated for a training input sentence pairs when humans disagree on how a NLI sentence pair should be classified.

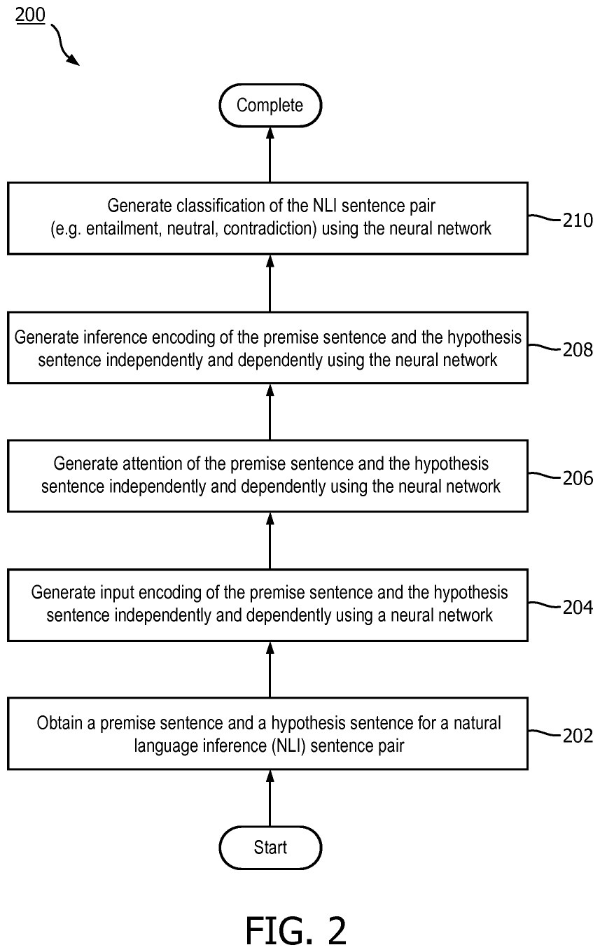

FIG. 2 describes an example process 200 for practicing selected aspects of the present disclosure, in accordance with various embodiments is disclosed. In many embodiments, a Bi-LSTM neural network model can be composed of the following components: input encoding, attention, inference encoding, and classification. For convenience, the operations of the flowchart are described with reference to a system that performs the operations. This system may include various components of various computer systems, including those described in FIG. 7. Moreover, while operations of process 200 are show in a particular order, this is not meant to be limiting. One or more operations may be reordered, omitted, and/or added.

At block 202, a premise sentence and a hypothesis sentence for a NLI sentence pair can be obtained. In many embodiments, NLI sentence pairs can be obtained in a manner similar to block 102 in FIG. 1.

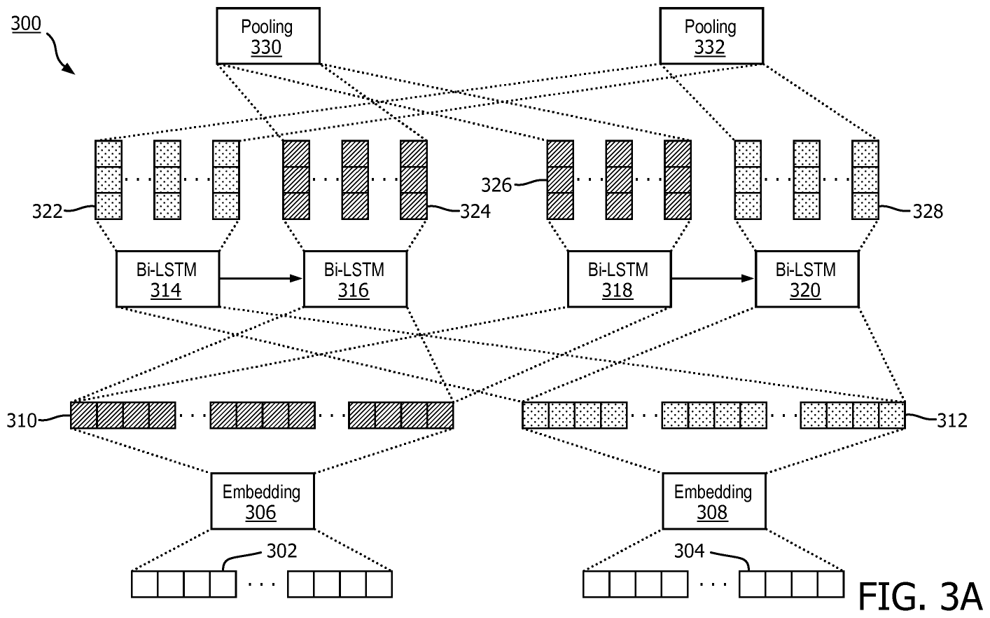

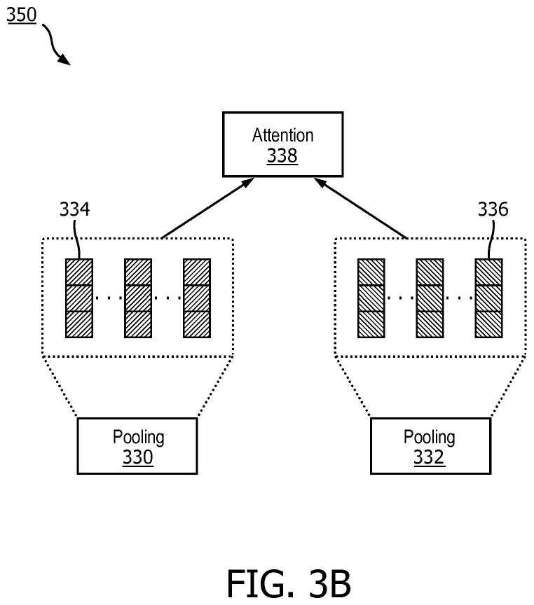

An input encoding of the premise sentence and the hypothesis sentence can independently and dependently be generated at block 204 using a neural network model. In many embodiments, the neural network model can contain recurrent neural network elements, for example, Bi-LSTM blocks. Input encoding in accordance with several embodiments will be discussed in detail in FIGS. 3A-3B.

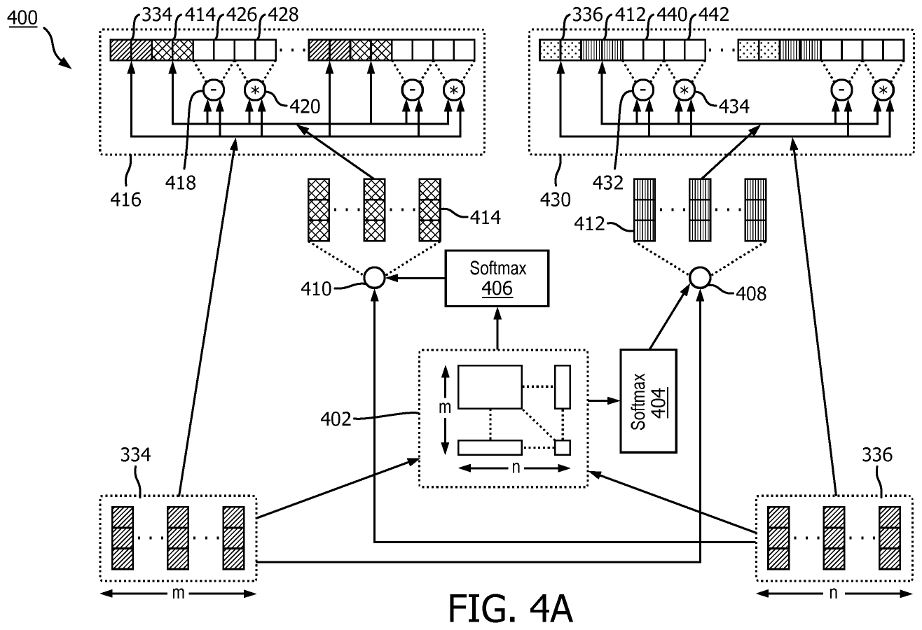

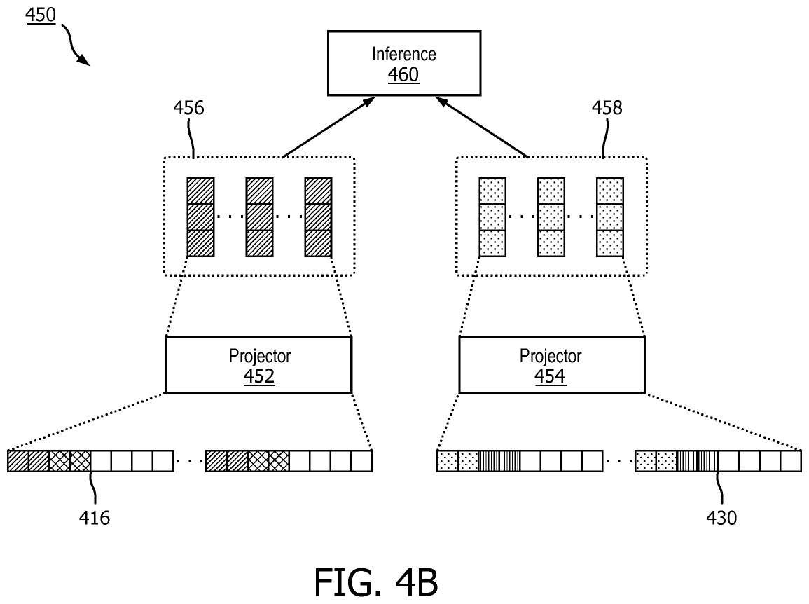

An attention of the premise sentence and the hypothesis sentence can independently and dependently be generated at block 206 using the neural network. Attention mechanisms can generate embedding for each word sequence in a sentence considering the other sentence. For example, attention mechanisms can correlate which words in the premise and the hypothesis have a higher importance. Attention in accordance with several embodiments will be discussed in detail in FIGS. 4A-4B.

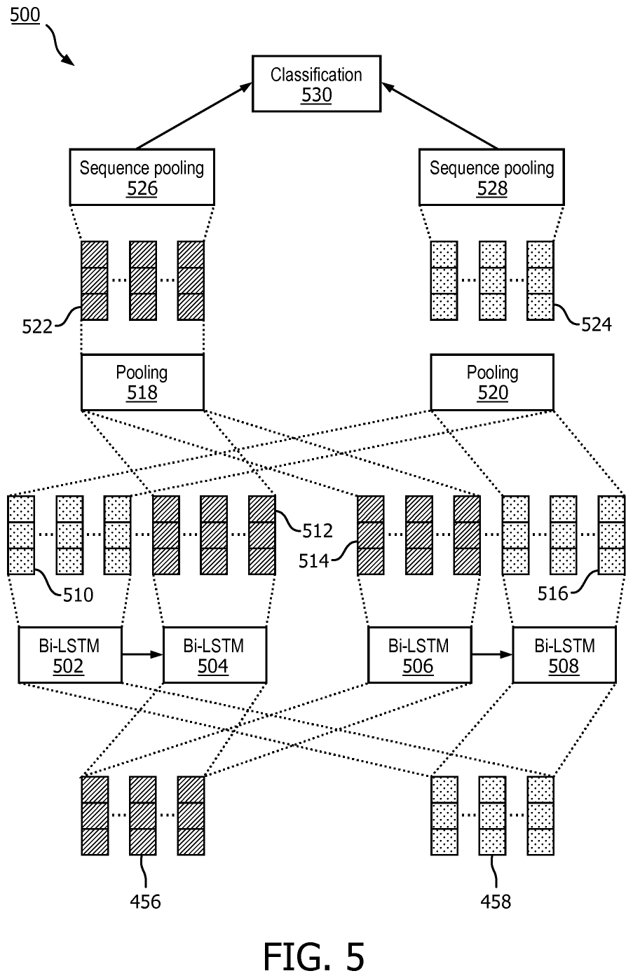

An inference encoding of the premise sentence and the hypothesis sentence can independently and dependently be generated at block 208 using the neural network model. In some embodiments, the neural network model at the inference encoding stage can contain recurrent neural networks elements, for example, Bi-LSTM blocks. Inference encoding in accordance with several embodiments will be discussed in detail in FIG. 5.

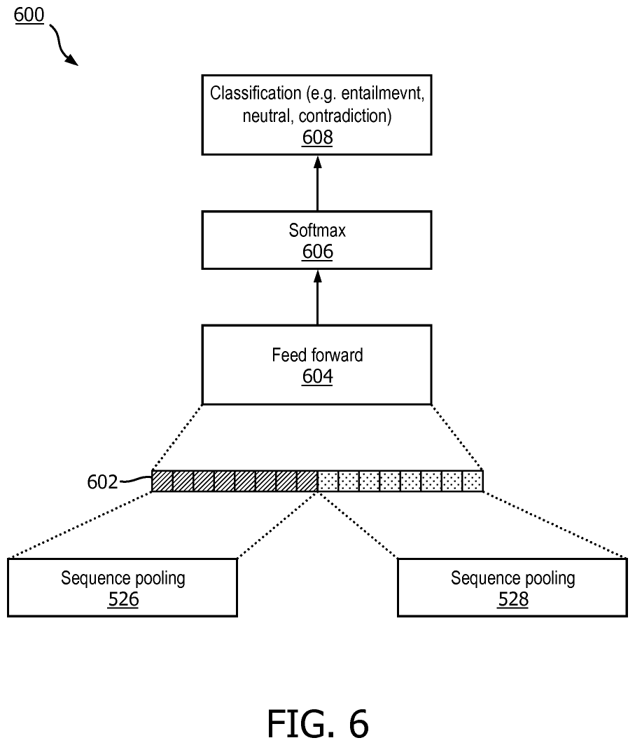

At block 210, a classification of the NLI sentence pair can be generated using the neural network. In several embodiments, classification labels can include: entailment, neutral, and contradiction. Classification in accordance with various embodiments will be discussed in detail in FIG. 6.

FIGS. 3A-3B illustrate an example input encoding in accordance with many embodiments. FIG. 3A and FIG. 3B illustrate images 300 and 350 respectively, which when combined can illustrate an example input encoding.

Image 300 contains an input premise sentence 302 and an input hypothesis sentence 304. Input premise sentence 302 can be passed to embedding 306, which can transform words in an input premise sentence into a word representation. Similarly, input hypothesis sentence can be passed to embedding 308 to transform words in an input hypothesis sentence into a word representation. In many embodiments, embedding 306 and/or embedding 308 can include a variety of word embeddings including: word2vec, GloVe, fastText, Gensim, Brown clustering, and/or latent semantic analysis.

Once an input premise sentence 302 has been embedded, a sequence of premise word embedding 310, referred to as simply a “premise” for simplification, can be represented by u. Premise 310 is represented by diagonal line shading, and any data originating from premise 310 is similarly represented by diagonal line shading throughout FIGS. 3-6 in accordance with some embodiments of the disclosure. Similarly, once an input hypothesis sentence 304 has been embedded, a sequence of hypothesis word embedding 312, referred to as simply a “hypothesis” for simplification, can be represented by v. Hypothesis 312 is represented by dotted shading, and any data originating from hypothesis 312 is similarly represented by dotted shading throughout FIGS. 3-6 in accordance with many embodiments of the disclosure. In some embodiments, u=[u₁, . . . , uₙ] can be a premise with length n and v=[v₁, . . . , vₘ] can be a hypothesis with length m, where uᵢ, vⱼϵ [symbol] ^{r} can be a word embedding of r—dimensional vector. In a variety of embodiments, the classification task can be to predict a label y that can indicate the logical relationship between premise u and hypothesis v.

In several embodiments, recurrent neural networks (RNNs) can be utilized for variable length sequence modeling. Additionally or alternatively a bidirectional Long Term Short Term (Bi-LSTM) block can be utilized for encoding the given premise 310 and hypothesis 312. Premise 310 and hypothesis 312 can be encoded with independent and dependent readings of Bi-LSTMs. For example, in an independent reading, the premise can be read without reading the hypothesis and similarly the hypothesis can be read without reading the premise. In a dependent reading, one sentence is read, and the reading of that first sentence is used in the reading of the second sentence. For example, in a dependent reading the premise can be read and the reading of the premise can be used to read the hypothesis.

Image 300 can contain four Bi-LSTM blocks which in a variety of embodiments, can work together to independently and dependently read the premise and hypothesis. Bi-LSTM block 314 can independently read hypothesis 312 to generate an independent hypothesis vector space 322. Similarly, Bi-LSTM block 318 can independently read premise 310 to generate independent premise vector space 326. Bi-LSTM block 316 can dependently read premise 310 using information passed from an independent reading of hypothesis 312 from Bi-LSTM block 314 to generate dependent premise vector space 324. Similarly, Bi-LSTM block 320 can dependently read hypothesis 312 using information from an independent reading of premise 310 passed from Bi-LSTM block 318 to generate dependent hypothesis vector space 328.

For ease of presentation, only a mathematical description of how to encode u depending on v (i. e. (u|v) will be described, but in many embodiments, the same procedures can be utilized for the reverse direction to encode (v|u).

In a variety of embodiments, to dependently encode u, v can be processed using the Bi-LSTM. Then u can be read through the Bi-LSTM that is initialized with previous reading finals states such as memory cell and hidden states. For example, a word can be represented by uᵢ and its context can depend on the other sentences such as v.

v̅,sᵥ=BiLSTM (v,0)

û,−=BiLSTM (u,sᵥ) (1)

ū,sᵤ=BiLSTM (u,0)

\hat{v},−=BiLSTM (v,sᵤ) (2)

where {ūϵ [symbol] ^{n×2d},ûϵ [symbol] ^{n×2d},sᵤ} and {\hat{v}ϵ [symbol] ^{m×2d},\hat{v}ϵ [symbol] ^{m×2d},sᵥ} are the independent reading sequences, dependent reading sequences, and Bi-LSTM final state of independent reading of u and v respectively (i.e. {independent reading sequences, dependent reading sequences, Bi-LSTM final state of independent reading of u or v}). In can be noted that “-” in these equations means that the associated variable and its value is unimportant. Bi-LSTM inputs (i.e. premise 310 and hypothesis 312) can be the word embedding sequence.

Independent and dependent reading embeddings from Bi-LSTM blocks can be passed to pooling processes. Dependent premise vector space 324 and independent premise vector space 326 can be passed to pooling 330. Additionally or alternatively, independent hypothesis vector space 322 and dependent hypothesis vector space 328 can be passed to pooling 332. Pooling 330 and pooling 332 can combine data passed to them in different ways including: max pooling, average pooling, L2 norm pooling etc.

Image 350 in FIG. 3B contains the pooling 330 and pooling 332 processes represented in FIG. 3A. The output of pooling 330 is a state vector 334 can represents the pooling of independent and dependent reading of the premise, and similarly the output of pooling 332 is a state vector 336 can represent the pooling of independent and dependent readings of the hypothesis. In several embodiments, state vector 334 and state vector 336 can be passed to an attention mechanism 338. In some embodiments, the input encoding mechanism can yield a richer representation for both premise and hypothesis by taking the history of each other into account. An attention mechanism in accordance with some embodiments of the disclosure will be discussed in FIGS. 4A-4B.

FIGS. 4A-4B illustrate an example attention mechanism in accordance with many embodiments. Attention mechanisms in accordance with a variety of embodiments of the disclosure can generate an embedding for each word sequence in a sentence considering the other sentence. Image 400 in FIG. 4A can contain a state vector 334 with a length of m words, which represents the pooling of independent and dependent reading of the premise, and a state vector 336 with a length of n words, which represents the pooling of independent and dependent readings of the hypothesis similar to the state vectors illustrated in FIG. 3B. State vectors 334 and 336 can be combined to form a matrix 402 of size m×n. Matrix 402 can be the input into a softmax function 404 and a softmax function 406. In some embodiments, softmax function 404 can be over the first dimension and softmax function 406 can be over the second dimension. Summation element 410 can combine the output of softmax function 406 with state vector 336 to generate attentional representation 414. Attentional representation 414 is visually represented by cross-hatches. Similarly, summation element 408 can combine the output of softmax function 404 with state vector 334 to generate attentional representation 412. Attentional representation 412 is visually represented by vertical lines.

In some embodiments, an attention mechanism can pass input embedding, attentional embedding, the difference of input embedding and attentional embedding, and the element wise product of input embedding and attentional embedding and attention output.

A premise attention output 416 can receive input from state vector 334 and attentional representation 414. A difference element 418 can compute the difference between state vector 334 and attentional representation 414 to generate difference output 426. An element wise product element 420 can compute an element wise product between state vector 334 and attentional representation 414 to generate element wise product output 428. In many embodiments, premise attention output 416 can represent one or more sequences of words, each word comprising elements of: state vector 334, attentional representation 414, difference output 426, and element wise product output 428.

Similarly, in several embodiments, a hypothesis attention output 430 can receive input from state vector 336 and attentional representation 412. A difference element 432 can compute the difference between state vector 336 and attentional representation 412 to generate difference output 440. An element wise product element 434 can compute an element wise product between state vector 336 and attentional representation 412 to generate element wise product output 442. In some embodiments, hypothesis attention output 430 can represent one or more sequences of words, each word comprising elements of: state vector 336, attentional representation 412, difference output 440, and element wise product output 442.

Image 450 in FIG. 4B contains premise attention output 416 and hypothesis attention output 430. Projector 452 can be a feed-forward layer which can transform the premise attention output 416 into premise attention state vector 456. Similarly, projector 454 can be a feed-forward layer which can transform the hypothesis attention output 430 into hypothesis attention state vector 458. In many embodiments, premise attention state vector 456 and hypothesis attention state vector 458 can be a lower dimensional space than the input to the corresponding projectors. Premise attention state vector 456 and hypothesis attention state vector 458 can be passed to inference encoding 460. Inference encoding in accordance with some embodiments will be discussed in FIG. 5.

Additionally or alternatively, in some embodiments, attention can be performed by a soft alignment method which can associate the relevant sub-components between the given premise and hypothesis. In deep learning models, such purpose is often achieved with a soft attention mechanism. In many embodiments, the unnormalized weights can be computed as the similarity of hidden states of the premise and hypothesis with Equation 3. Equation 3, for example, can be an energy function.

eᵢⱼ=ûᵢ\hat{v}ⱼ^{T},iϵ[1,n],jϵ[1,m] (3)

where ûᵢ and \hat{v}ⱼ are the dependent reading hidden representations of u and v respectively. In some embodiments, for each word in either the premise or the hypothesis, the relevant semantics in the other sentence can be extracted and composed according to eᵢⱼ. In various embodiments, Equations 4 and 5 can provide formal and specific details of this procedure.

$$\begin{matrix}{\tilde{u}}_{i} = {\sum }_{j = 1}^{m} \frac{exp ( {e}_{i j} )}{{Σ}_{k = 1}^{m} exp ( {e}_{i k} )} {\hat{v}}_{j} , i ∈ [ 1 , n ] & ( 4 ) \\ {\tilde{v}}_{j} = {\sum }_{i = 1}^{n} \frac{exp ( {e}_{i j} )}{{Σ}_{k = 1}^{n} exp ( {e}_{k j} )} {\hat{u}}_{i} , j ∈ [ 1 , m ] & ( 5 )\end{matrix}$$

where ũᵢ represents the extracted relevant information of \hat{v} by attending to ûᵢ while \tilde{v}ⱼ represents the extracted relevant information of û by attending to \hat{v}ⱼ.

In many embodiments, the collected attentional information can be further enriched by passing the concatenation of the tuples (ûᵢ, ũᵢ) or (\hat{v}ⱼ, \tilde{v}ⱼ). To additionally add similarity and closeness measures, in some embodiments, the difference and element wise product for tuples (ûᵢ, ũᵢ) and (\hat{v}ⱼ, \tilde{v}ⱼ) that represent the similarly and closeness

The difference and element-wise product are then concatenated with the computed vectors, (ûᵢ, ũᵢ) or (\hat{v}ⱼ, \tilde{v}ⱼ), respectively. Additionally or alternatively, a feed-forward neural layer with ReLU activation function can project the concatenated vectors form 8d-dimensional vector space into d-dimensional (Equations 6 and 7). In many embodiments, this can capture deeper dependences between the sentences besides lowering the complexities of vector representations.

aᵢ=[ûᵢ,ũᵢ,ûᵢ−ũᵢ,ûᵢ⊚ũᵢ]

pᵢ=ReLU(Wₚaᵢ+bₚ) (6)

bⱼ=[\hat{v}ⱼ,\tilde{v}ⱼ,\hat{v}ⱼ−\tilde{v}ⱼ,\hat{v}ⱼ⊚\tilde{v}ⱼ]

qⱼ=ReLU(Wₚbⱼ+bₚ) (7)

Here ⊚ stands for element-wise product, while Wₚϵ [symbol] ^{8d×d} and bₚϵ [symbol] ^{d} are the trainable weights and biases of the projector layer respectively.

FIG. 5 illustrates an example inference encoding in accordance with several embodiments. Image 500 includes premise attention state vector 456 and hypothesis attention state vector 458 similar to the state vectors illustrated in FIG. 4B. In a variety of embodiments, inference encoding can encode premise and hypothesis data using independent readings and dependent readings in a manner similar to the encoding mechanisms used in input encoding steps of a neural network model described in FIGS. 3A-3B. Premise attention state vector 456 can be represented by p and attention state vector 458 can be represented by q. An aggregation of p and q can be performed in a sequential manner to avoid losing an effect of latent variables that might rely on the sequence of matching vectors.

In a variety of embodiments, image 500 can contain four Bi-LSTM blocks which similarly to input encoding, can work together to independently and dependently read premise attention state vector 456 and hypothesis attention state vector 458. Bi-LSTM block 506 can independently read premise attention state vector 456 to generate independent reading premise state vector 514. Similarly, Bi-LSTM block 502 can independently read hypothesis attention state vector 458 to generate independent reading hypothesis state vector 510. Bi-LSTM block 504 can dependently read premise attention state vector 456 using additional information passed from an independent reading of hypothesis attention state vector 458 from Bi-LSTM block 502 to generate dependent reading premise state vector 512. Similarly, in many embodiments, Bi-LSTM block 508 can dependently read hypothesis attention state vector 458 using additional information passed from an independent reading of premise attention state vector 456 by Bi-LSTM block 506 to generate dependent reading hypothesis vector 516.

Independent and dependent readings of p and q can be passed to pooling processes. In various embodiments, dependent reading premise state vector 512 and independent reading premise state vector 514 can be passed to pooling processing 518 to generate premise inference state vector 522. Similarly, independent reading hypothesis state vector 510 and dependent reading hypothesis state vector 516 can be passed to pooling process 520 to generate hypothesis inference state vector 524. In some embodiments, additional pooling processes can be performed on the data. In some such embodiments, premise inference state vector 522 can be passes to sequence pooling 526 and similarly hypothesis inference state vector 524 can be passed to sequence pooling 528. Sequence pooling 526 and sequence pooling 528 can be utilized in a classification step such as classification 530. In a variety of embodiments, sequence pooling can generate a non-sequential tensor that can be a combination of different pooling methods including: max-pooling, avg-pooling, min-pooling, etc. A classification step for a neural network model similar to classification 530 will be discussed in detail in FIG. 6.

In alternative or additional embodiments, inference processes similar to those described in FIG. 5 can be performed in a manner similar to that described below. Instead of aggregating the sequences of matching vectors individually, a Bi-LSTM reading process (Equations 8 and 9) similar to the input encoding step can be utilized in accordance with some embodiment of the disclosure. Both independent readings (p̅ and q̅) and dependent readings (\hat{p} and \hat{q}) can be fed to a max pooling layer, which can select maximum values from each sequence of independent and dependent readings (p̅ᵢ and \hat{p}ᵢ) as shown in Equations 10 and 11. In yet another embodiment, this architecture can maximize the inferencing ability of the model by considering both independent and dependent readings.

q̅,s_{q}=BiLSTM (q,0)

\hat{p},−=BiLSTM (p,s_{q}) (8)

p̅,sₚ=BiLSTM (p,0)

\hat{q},−=BiLSTM (q,sₚ) (9)

\tilde{p}=MaxPooling (p̅,\hat{p}) (10)

\tilde{q}=MaxPooling (q̅,\hat{q}) (11)

In many embodiments, {p̅ϵ [symbol] ^{n×2d},\hat{p}ϵ [symbol] ^{n×2d},sₚ} and {q̅ϵ [symbol] ^{m×2d},\hat{q}ϵ [symbol] ^{m×2d},s_{q}} are the independent reading sequences, dependent reading sequences, and Bi-LSTM final state of independent reading of p and q respectively (i.e. {independent reading sequence, dependent reading sequence, Bi-LSTM final state of independent reading}). Bi-LSTM inputs can be the word embedding sequences and initial state vectors.

In some embodiments, \tilde{p}ϵ [symbol] ^{n×2d} and \tilde{q}ϵ [symbol] ^{m×2d} can be converted to fixed-length vectors with pooling, Uϵ [symbol] ^{4d} and Vϵ [symbol] ^{4d}. As shown in Equations 12 and 13, some embodiments may employ both max and average pooling and describe the overall inference relationship with concatenation of their outputs.

U=[MaxPooling (\tilde{p}),AvgPooling (\tilde{p})] (12)

V=[MaxPooling (\tilde{q}),AvgPooling (\tilde{q})] (13)

FIG. 6 illustrates an example classification in accordance with many embodiments. Image 600 contains sequence pooling 526 and sequence pooling 528 which in several embodiments can represent a sequence pooling similar to sequence pooling 526 and sequence pooling 528 illustrated in FIG. 5. Sequence pooling 526 and sequence pooling 528 can be concatenated into classification input 602. In many embodiments, classification input 602 can be fed into a feed-forward layer 604 and a softmax layer 606. Softmax layer 606 can generate a classification label 608 for the given premise and hypothesis NLI sentence pair (e.g., entailment, neutral, or contradiction).

Classification processes in accordance with many embodiments of the disclosure can be performed in a manner similar to that described below. The concatenation of U and V, for example, ([U, V]) can be fed into a multilayer perceptron (MLP) classifier that can include a hidden layer with tan h activation and softmax output layer. In a variety of embodiments, the model can be trained in an end-to end-manner.

Output=MLP ([U,V]) (14)

FIG. 7 is a block diagram of an example computing device 710 that may optionally be utilized to perform one or more aspects of techniques described herein. In some implementations, one or more of a client computing device, user-controlled resources engine 130, and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the processes of FIGS. 1 and 2.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

1. A method implemented with one or more processors, comprising:
obtaining data indicative of a premise and data indicative of a hypothesis, wherein the data indicative of the premise and the data indicative of the hypothesis form a natural language inference classification pair;
processing the data indicative of the hypothesis independently using a first recurrent network to generate first independent hypothesis data;
processing the data indicative of the premise independently using a third recurrent network to generate third independent premise data;
processing the data indicative of the premise dependently with the first independent hypothesis data using a second recurrent network to generate second dependent premise data;
processing the data indicative of the hypothesis dependently with the third independent premise data using a fourth recurrent network to generate fourth dependent hypothesis data;
pooling the second dependent premise data and the third independent premise independent data to combine independent and dependent premise data and generate pooled premise data;
pooling the first independent hypothesis data and the fourth dependent hypothesis data to combine independent and dependent hypothesis data and generate pooled hypothesis data; and
generating a pooled classification output by combining the pooled premise data and the pooled hypothesis data, wherein the pooled classification output is selected from the group consisting of entailment, neutral, and contradiction.

2. The method of claim 1, further comprising:
generating data indicative of an attention matrix by combining the pooled premise data with the pooled hypothesis data;
generating attention softmax data by calculating the attention matrix with a softmax function;
generating an additional representation of the hypothesis data by combining the pooled hypothesis data with the attention softmax data;
generating an additional representation of the premise data by combining the pooled premise data with the attention softmax data;
generating data representative of dependent premise attention embedding by combining the pooled premise data, the additional representation of the hypothesis data, a difference between the pooled premise data and the additional representation of the hypothesis data, and an element wise product between the pooled premise data and the additional representation of the hypothesis data;
generating data representative of dependent hypothesis attention embedding by combining the pooled hypothesis data, the additional representation of the premise data, a difference between the pooled hypothesis data and the additional representation of the premise data, and an element wise product between the pooled hypothesis data and the additional representation of the premise data;
generating concatenated premise vectors data using a premise projector receiving data representative of dependent premise attention embedding, wherein the premise projector is a feed-forward neural layer; and
generating concatenated hypothesis vector data using a hypothesis projector receiving data representative of dependent hypothesis attention embedding, wherein the hypothesis projector is a feed-forward neural layer.

3. The method of claim 2, further comprising:
processing the concatenated hypothesis vectors data independently using a fifth recurrent network to generate fifth hypothesis independent recurrent network data;
processing the concatenated premise vector data independently using a seventh recurrent network to generate seventh premise independent recurrent network data;
processing the concatenated premise vectors data dependently with the fifth hypothesis independent recurrent network data using a sixth recurrent network to generate sixth premise dependent recurrent network data;
processing the concatenated hypothesis vector data dependently with the seventh premise independent recurrent network data using an eighth recurrent network to generate eighth hypothesis dependent recurrent network data;
pooling the sixth premise dependent recurrent network data and the seventh premise independent recurrent network data to combine independent and dependent premise data and generate second pooled premise data;
pooling the fifth hypothesis independent recurrent network data and the eighth hypothesis dependent recurrent network data to combine independent and dependent hypothesis data and generate second pooled hypothesis data;
pooling the second pooled premise data to generate premise sequence pooling data which independently combines the second pooled premise data; and
pooling the second pooled hypothesis data generate hypothesis sequence pooling data which independently combines the second pooled hypothesis data.

4. The method of claim 3, further comprising:
generating concatenation data of the premise sequence pooling data and the hypothesis sequence pooling data;
classifying the concatenation data using a feed-forward neural layer which feeds into an additional softmax function, wherein the output of classifying the concatenation data indicates a relationship between the natural language inference pair and is selected from the group consisting of entailment, neutral, and contradiction.

5. The method of claim 4, wherein entailment indicates the data indicative of the hypothesis is entailed by the data indicative of the premise in a natural language inference, wherein contradiction indicates the data indicative of the hypothesis is contradicted by the data indicative of the premise in the natural language inference, and neutral indicates the data indicative of the hypothesis is not a entailed or contradicted by the data indicative of the premise in the natural language inference.

6. The method of claim 1, wherein the first recurrent network is a first bidirectional long short term memory network, the second recurrent network is second Bi-LSTM network, the third recurrent network is a third Bi-LSTM network, the fourth recurrent network is a fourth Bi-LSTM network, the fifth recurrent network is a fifth Bi-LSTM network, the sixth recurrent network is a sixth Bi-LSTM network, the seventh recurrent network is a seventh Bi-LSTM network, and the eighth recurrent network is an eighth Bi-LSTM network.

7. The method of claim 1, further comprising preprocessing the data indicative of the premise and the data indicative of the hypothesis which form the natural language inference classification pair.

8. At least one non-transitory computer-readable medium comprising instructions that, in response to execution of the instructions by one or more processors, cause one or more processors to perform the following operations:
obtaining data indicative of a premise and data indicative of a hypothesis, wherein the data indicative of the premise and the data indicative of the hypothesis form a natural language inference classification pair;
processing the data indicative of the hypothesis independently using a first recurrent network to generate first independent hypothesis data;
processing the data indicative of the premise independently using a third recurrent network to generate third independent premise data;
processing the data indicative of the premise dependently with the first independent hypothesis data using a second recurrent network to generate second dependent premise data;
processing the data indicative of the hypothesis dependently with the third independent premise data using a fourth recurrent network to generate fourth dependent hypothesis data;
pooling the second dependent premise data and the third independent premise independent data to combine independent and dependent premise data and generate pooled premise data;
pooling the first independent hypothesis data and the fourth dependent hypothesis data to combine independent and dependent hypothesis data and generate pooled hypothesis data; and
generating a pooled classification output by combining the pooled premise data and the pooled hypothesis data, wherein the pooled classification output is selected from the group consisting of entailment, neutral, and contradiction.

9. The at least one non-transitory computer-readable medium of claim 8, further comprising:
generating data indicative of an attention matrix by combining the pooled premise data with the pooled hypothesis data;
generating attention softmax data by calculating the attention matrix with a softmax function;
generating an additional representation of the hypothesis data by combining the pooled hypothesis data with the attention softmax data;
generating an additional representation of the premise data by combining the pooled premise data with the attention softmax data;
generating data representative of dependent premise attention embedding by combining the pooled premise data, the additional representation of the hypothesis data, a difference between the pooled premise data and the additional representation of the hypothesis data, and an element wise product between the pooled premise data and the additional representation of the hypothesis data;
generating data representative of dependent hypothesis attention embedding by combining the pooled hypothesis data, the additional representation of the premise data, a difference between the pooled hypothesis data and the additional representation of the premise data, and an element wise product between the pooled hypothesis data and the additional representation of the premise data;
generating concatenated premise vectors data using a premise projector receiving data representative of dependent premise attention embedding, wherein the premise projector is a feed-forward neural layer; and
generating concatenated hypothesis vector data using a hypothesis projector receiving data representative of dependent hypothesis attention embedding, wherein the hypothesis projector is a feed-forward neural layer.

10. The at least one non-transitory computer-readable medium of claim 9, further comprising:
processing the concatenated hypothesis vectors data independently using a fifth recurrent network to generate fifth hypothesis independent recurrent network data;
processing the concatenated premise vector data independently using a seventh recurrent network to generate seventh premise independent recurrent network data;
processing the concatenated premise vectors data dependently with the fifth hypothesis independent recurrent network data using a sixth recurrent network to generate sixth premise dependent recurrent network data;
processing the concatenated hypothesis vector data dependently with the seventh premise independent recurrent network data using an eighth recurrent network to generate eighth hypothesis dependent recurrent network data;
pooling the sixth premise dependent recurrent network data and the seventh premise independent recurrent network data to combine independent and dependent premise data and generate second pooled premise data;
pooling the fifth hypothesis independent recurrent network data and the eighth hypothesis dependent recurrent network data to combine independent and dependent hypothesis data and generate second pooled hypothesis data;
pooling the second pooled premise data to generate premise sequence pooling data which independently combines the second pooled premise data; and
pooling the second pooled hypothesis data generate hypothesis sequence pooling data which independently combines the second pooled hypothesis data.

11. The at least one non-transitory computer-readable medium of claim 10, further comprising:
generating concatenation data of the premise sequence pooling data and the hypothesis sequence pooling data;
classifying the concatenation data using a feed-forward neural layer which feeds into an additional softmax function, wherein the output of classifying the concatenation data indicates a relationship between the natural language inference pair and is selected from the group consisting of entailment, neutral, and contradiction.

12. The at least one non-transitory computer-readable medium of claim 11, wherein entailment indicates the data indicative of the hypothesis is entailed by the data indicative of the premise in a natural language inference, wherein contradiction indicates the data indicative of the hypothesis is contradicted by the data indicative of the premise in the natural language inference, and neutral indicates the data indicative of the hypothesis is not a entailed or contradicted by the data indicative of the premise in the natural language inference.

13. The at least one non-transitory computer-readable medium of claim 8, wherein the first recurrent network is a first bidirectional long short term memory (Bi-LSTM) network, the second recurrent network is second Bi-LSTM network, the third recurrent network is a third Bi-LSTM network, the fourth recurrent network is a fourth Bi-LSTM network, the fifth recurrent network is a fifth Bi-LSTM network, the sixth recurrent network is a sixth Bi-LSTM network, the seventh recurrent network is a seventh Bi-LSTM network, and the eighth recurrent network is an eighth Bi-LSTM network.

14. The at least one non-transitory computer-readable medium of claim 8, further comprising preprocessing the data indicative of the premise and the data indicative of the hypothesis which form the natural language inference classification pair.

15. A system comprising one or more processors and memory operably coupled with the one or more processors, wherein the memory stores instructions that, in response to execution of the instructions by one or more processors, cause the one or more processors to perform the following operations:
obtaining data indicative of a premise and data indicative of a hypothesis, wherein the data indicative of the premise and the data indicative of the hypothesis form a natural language inference classification pair;
processing the data indicative of the hypothesis independently using a first recurrent network to generate first independent hypothesis data;
processing the data indicative of the premise independently using a third recurrent network to generate third independent premise data;
processing the data indicative of the premise dependently with the first independent hypothesis data using a second recurrent network to generate second dependent premise data;
processing the data indicative of the hypothesis dependently with the third independent premise data using a fourth recurrent network to generate fourth dependent hypothesis data;
pooling the second dependent premise data and the third independent premise independent data to combine independent and dependent premise data and generate pooled premise data;
pooling the first independent hypothesis data and the fourth dependent hypothesis data to combine independent and dependent hypothesis data and generate pooled hypothesis data; and
generating a pooled classification output by combining the pooled premise data and the pooled hypothesis data, wherein the pooled classification output is selected from the group consisting of entailment, neutral, and contradiction.

16. The system of claim 15, further comprising:
generating data indicative of an attention matrix by combining the pooled premise data with the pooled hypothesis data;
generating attention softmax data by calculating the attention matrix with a softmax function;
generating an additional representation of the hypothesis data by combining the pooled hypothesis data with the attention softmax data;
generating an additional representation of the premise data by combining the pooled premise data with the attention softmax data;
generating data representative of dependent premise attention embedding by combining the pooled premise data, the additional representation of the hypothesis data, a difference between the pooled premise data and the additional representation of the hypothesis data, and an element wise product between the pooled premise data and the additional representation of the hypothesis data;
generating data representative of dependent hypothesis attention embedding by combining the pooled hypothesis data, the additional representation of the premise data, a difference between the pooled hypothesis data and the additional representation of the premise data, and an element wise product between the pooled hypothesis data and the additional representation of the premise data;
generating concatenated premise vectors data using a premise projector receiving data representative of dependent premise attention embedding, wherein the premise projector is a feed-forward neural layer; and
generating concatenated hypothesis vector data using a hypothesis projector receiving data representative of dependent hypothesis attention embedding, wherein the hypothesis projector is a feed-forward neural layer.

17. The system of claim 16, further comprising:
processing the concatenated hypothesis vectors data independently using a fifth recurrent network to generate fifth hypothesis independent recurrent network data;
processing the concatenated premise vector data independently using a seventh recurrent network to generate seventh premise independent recurrent network data;
processing the concatenated premise vectors data dependently with the fifth hypothesis independent recurrent network data using a sixth recurrent network to generate sixth premise dependent recurrent network data;
processing the concatenated hypothesis vector data dependently with the seventh premise independent recurrent network data using an eighth recurrent network to generate eight hypothesis dependent recurrent network data;
pooling the sixth premise dependent recurrent network data and the seventh premise independent recurrent network data to combine independent and dependent premise data and generate second pooled premise data;
pooling the fifth hypothesis independent recurrent network data and the eighth hypothesis dependent recurrent network data to combine independent and dependent hypothesis data and generate second pooled hypothesis data;
pooling the second pooled premise data to generate premise sequence pooling data which independently combines the second pooled premise data; and
pooling the second pooled hypothesis data generate hypothesis sequence pooling data which independently combines the second pooled hypothesis data.

18. The system of claim 17, further comprising:
generating concatenation data of the premise sequence pooling data and the hypothesis sequence pooling data;
classifying the concatenation data using a feed-forward neural layer which feeds into an additional softmax function, wherein the output of classifying the concatenation data indicates a relationship between the natural language inference pair and is selected from the group consisting of entailment, neutral, and contradiction.

19. The system of claim 18, wherein entailment indicates the data indicative of the hypothesis is entailed by the data indicative of the premise in a natural language inference, wherein contradiction indicates the data indicative of the hypothesis is contradicted by the data indicative of the premise in the natural language inference, and neutral indicates the data indicative of the hypothesis is not a entailed or contradicted by the data indicative of the premise in the natural language inference.

20. The system of claim 15, wherein the first recurrent network is a first bidirectional long short term memory (Bi-LSTM) network, the second recurrent network is second Bi-LSTM network, the third recurrent network is a third Bi-LSTM network, the fourth recurrent network is a fourth Bi-LSTM network, the fifth recurrent network is a fifth Bi-LSTM network, the sixth recurrent network is a sixth Bi-LSTM network, the seventh recurrent network is a seventh Bi-LSTM network, and the eighth recurrent network is an eighth Bi-LSTM network.
